(19) United States
(12) Patent Application Publication
(10) Pub. No.: US 2002/0187272 A1
(43) Pub. Date: Dec. 12, 2002

(54) Method and apparatus for forming thin film of organic material

(75) Inventors: Gen Kojima, Kanagawa (JP); Kunio Masumo, Kanagawa (JP); Akira Takahashi, Kanagawa (JP); Goro Asari, Kanagawa (JP)

Correspondence Address: OBLON SPIVAK MCCLELLAND MAIER & NEUSTADT PC, FOURTH FLOOR, 1755 JEFFERSON DAVIS HIGHWAY, ARLINGTON, VA, 22202, US

(73) Assignee: ASAHI GLASS COMPANY LIMITED, TOKYO (JP)

(21) Appl. No.: 10/153,742

(22) Filed: May 24, 2002

Related U.S. Application Data
(63) Continuation of application No. PCT/JP00/08341, filed on Nov. 27, 2000.

(30) Foreign Application Priority Data
Nov. 26, 1999 (JP) 11-336321

(51) Int. Cl. B05D 1/02; B05B 1/28

(52) U.S. Cl. 427/421; 118/304; 118/326

(57) ABSTRACT

Coating of a substrate with an organic material, which is characterized in that it comprises liquefying by pressurization a medium which is gaseous at ordinary temperature under 1 atom and liquefies at ordinary temperature under a pressure of 100 atom or less, dissolving or dispersing an organic material in the liquefied medium, and spraying the resulting material mixture onto a substrate in an inert gas atmosphere or comprises bringing a medium having a critical temperature of ordinary temperature or lower and a critical pressure of 100 atm or less into a supercritical state, dissolving or dispersing an organic material in the medium, and spraying the resulting material mixture onto a substrate in an inert gas atmosphere.

### TECHNICAL FIELD

The present invention relates to a new technique for forming thin films. In particular, the present invention relates to novel method and apparatus for forming thin film of organic materials having optical and/or electrical functions (hereinafter referred to as being optically and electrically functional) such as electroluminescent, photoluminescent, photovoltaic and photoconductive materials and those used for optical memories, optical switches, light modulators, photoresists and magnetic memories, among thin films of various organic materials formed by using a core technology in the so-called high-tech field which emphasizes compactness and lightness in weight.

### BACKGROUND ART

As techniques for formation of thin film of optically and electrically functional organic materials, for example, to manufacture sophisticated devices, vacuum vapor deposition, CVD (Chemical Vapor Deposition), sputtering, electron beam vapor deposition, ion beam vapor deposition, spin coating, ink jet coating, plating, electroless plating, LB (Langmur Bloggett) membrane formation and screen printing are conventionally known and have practical applications which utilize their individual characteristics. However, they are not necessarily satisfactory from all aspects and have a lot of problems and room for improvement.

For example, the above-mentioned vapor deposition methods, CVD and sputtering require very special and costly apparatuses to maintain a high vacuum in the system. Besides, sputtering, plasma sputtering, electron beam vapor deposition and ion beam vapor deposition require high energy electromagnetic waves that may damage delicate optically and electrically functional organic materials or the substrate.

Spin coating, plating and electroless plating are not suitable for precisive coating over very small regions, i.e., segment dot coating, though it may be possible to form coatings inexpensively with relatively simple apparatuses.

Further, LB membrane formation is applicable to particular combinations of materials and substrates but is not versatile or suitable for segment dot coating.

In contrast, ink jet coating and screen printing are suitable for segment dot coating but not for solid coating over large areas. Further, because of problems in selection of the solvent, drying and wettability, their applications are limited.

On the other hand, brush coating, roll coating, curtain coating, doctor blade coating, spray coating, powder coating, electrostatic coating, plating and electroless plating are known for general applications in the field of painting and coating which are not intended for optically and electrically functional organic materials. These painting and coating techniques used for materials which have to have no particular functions do not have to meet strict requirements regarding the coating environment and conditions and the uniformity of the coating and do not require applicability to fine segment dot coating, either. Therefore, it is difficult to directly apply these coating techniques to formation of thin films of optically and electrically functional organic materials.

Recently the application of carbon dioxide gas and other media in supercritical states (hereinafter referred to as supercritical fluids) to coatings or paints has been studied and proposed as a new technology. Japanese Unexamined Patent Publications JP-A-5-132656 and JP-A-8-231903 and Japanese PCT Publication JP-A-9-503158 disclose techniques for applying ordinary materials such as paints, enamels, lacquers, varnishes, adhesives, chemical agents, release agents, protective oils, nonaqueous cleaning agents and agricultural coatings. However, no attempt has been made to apply theses techniques to formation of thin films of optically and electrically functional organic materials in production of sophisticated devices.

In formation of thin films of optically and electrically functional organic materials, not only it is crucial to form thin films which are uniform in terms of the surface conditions, thickness and denseness, but also techniques that minimize the damage to thin films and hindrances to their functions by chemical factors such as highly active substances such as moisture and oxygen and physicochemical factors such as high energy and high temperature are needed.

The present invention has been accomplished in view of the above-mentioned circumstance and is aimed at providing novel method and apparatus for forming a thin film of an organic material (1) which give little chemical or physicochemical damage to the organic material and the substrate during application of the optically and electrically functional organic material, (2) which afford uniform thin films, (3) which do not require special conditions or apparatus such as a high vacuum, a high voltage, a plasma and high energy electromagnetic waves, (4) which enable formation of films of compounds which are hardly soluble in ordinary organic solvents or not sublimable, (5) which enable quick film formation with a simple drying step, (6) which allow continuous and batchwise film formation depending on the case, and (7) which are applicable both to uniform solid coating over large areas and to segment dot coating over small areas.

### DISCLOSURE OF THE INVENTION

The present inventors have found out that novel method and apparatus for forming a thin film, comprising (A) dissolving or dispersing an optically and electrically functional organic material in a liquefiable gas which is gaseous at ordinary temperature under atmospheric pressure and liquefies at ordinary temperature under a pressure of 100 atm or less, under such conditions that the organic material does not deteriorate, and (B) coating a substrate with the resulting solution or dispersion in an inert gas atmosphere that neither damages the optically and electrically functional organic material nor the substrate chemically or physicochemically, and accomplished the present invention.

Namely, the present invention provides a method for forming a thin film of an organic material, which comprises liquefying by pressurization a medium which is gaseous at ordinary temperature under 1 atom and liquefies at ordinary temperature under a pressure of 100 atom or less, dissolving or dispersing an organic material in the liquefied medium, and spraying the resulting material mixture onto a substrate in an inert gas atmosphere to coat the substrate with the organic material.

The present invention also provides a method for forming a thin film of an organic material, which comprises bringing a medium having a critical temperature of ordinary temperature or lower and a critical pressure of 100 atm or less into a supercritical state, dissolving or dispersing an organic material in the medium, and spraying the resulting material mixture onto a substrate in an inert gas atmosphere to coat the substrate with the organic material.

The present invention further provides an apparatus for forming a thin film of an organic material, which comprises a chamber portion to be loaded with a substrate which has an internal space to be filled with an inert gas, an spraying means which has an exhaust nozzle through which a material mixture obtained by dissolving or dispersing an organic material in a medium is sprayed, an introducing means which introduces the inert gas into the internal space, and an exhaustion means which exhausts the inert gas and the material mixture to keep the pressure in the internal space at a given value.

### BRIEF EXPLANATION OF THE DRAWINGS

FIG. 1: A conceptual diagram of an embodiment of the apparatus of the present invention.

FIG. 2: A conceptual diagram of an embodiment of the apparatus of the present invention.

### BEST MODE FOR CARRYING OUT THE INVENTION

As the organic material in the present invention, various materials may be used. For example, an optically and electrically functional material, particularly an optically and electrically functional organic material which emits light, is preferred. In this case, the source of the excitation energy may be electricity or light. In the former case, the material is called an electroluminescent organic material, and in the latter case, a photoluminescent organic material. Other optically and electrically functional organic materials such as photovoltaic and photoconductive organic materials for solar cells and organic recording media may be used. In addition, the present invention can be applied to formation of thin films of associated materials required for the functions of these optically and electrically functional organic materials such as electron conductive materials and hole conductive materials.

Examples of specific compounds include electroluninescent organic material such as anthracene, perillene, hydroxyquinoline aluminum, distyrylbiphenyl, phthalocyanine, rubrene, quinacridon, poly(paraphenylenevinylene), polyalkylthiophene, polysilane and their derivatives, photoluminescent organic materials such as anthracene, perillene, rubrene, poly(paraphenylenevinylene) and their derivatives, photovoltaic organic materials such as rare earth complex compounds and their derivatives, photoconductive organic materials such as phthalocyanine compounds, azo compounds and polyvinylcarbazole, organic recording media such as spiropyran compounds, cyanine dyes, azo metal dyes and their derivatives, electron conductive materials such as hydroxyquinoline aluminum, oxadiazole, berillium complexes, silole and their derivatives and hole conductive materials such as triphenylamine, triphenylmethane, hydrazone compounds, stilbene compounds, starbust (triphenylamine polymer) compounds, polyvinylcarbazole and their derivatives.

They are used singly or in combination to form a thin film on substrates by coating.

The method for forming a thin film of the present invention can form a film of an organic material with a thickness of 10 μm or less, even into an ultrathin film with a thickness of 1 μm or less.

Examples of the material constituting the substrate used in the present invention, which is intended to be coated with a thin film of an optical or electrical material and then used as a device or a module, include transparent electrical insulating materials such as glass, silica, polyethylene terephthalate (PET) and polycarbonate (PC), transparent electrically conductive materials such as indium tin oxide (ITO) and electrode materials such as silver, aluminum, magnesium, lithium and carbon, though there is no particular restriction. The substrate material may be a special electrically conductive material such as magnesium alloys and lithium alloys containing metals having work functions of 4 eV or less.

As the medium in the present invention, any liquefied medium obtained by liquefying by pressurization a liquefiable gas which is gaseous at ordinary temperature (such as 50° C.) under atmospheric pressure (i.e., 1 atm), liquefies under a relative small pressure and is inert to the organic material applied as a coating, is preferably used, as long as it damages neither the organic material applied as a coating nor the substrate chemically or physicochemically. As such media, carbon-containing compounds having at most three carbon atoms, in particular carbon-containing compounds called carbon dioxide gas, flons, paraffins or olefins, which have at most three carbon atoms and contain hydrogen, fluorine, chlorine or oxygen (such as methane, ethane, ethylene, propane, chlorotrifluoromethane and monofluoromethane) are used preferably. These media may be used singly or in combination and used after appropriate selection and formulation according to the properties of the organic material applied as a coating.

In the present invention, the material applied as a coating may be dissolved or dispersed in the above-mentioned media (liquefiable gas) in a supercritical state. It advantageously facilitates formation of films of compounds which are hardly soluble in ordinary solvents or not sublimable. In this case, any medium as mentioned above may be used as the medium, and especially carbon dioxide is preferably used.

When the organic material applied as a coating is dissolved or dispersed in a medium in a supercritical state, the medium has to have a critical temperature of ordinary temperature or lower so that it is brought into a supercritical state at ordinary temperature (such as 50° C.), and the medium has to have a critical pressure of 100 atm or less so that the dissolution or dispersion of the organic material can be carried out at 100 atm or less.

When the organic material applied as a coating is dissolved or dispersed in the medium, it is crucial to dissolve it sufficiently or disperse it to fine particles. From this standpoint, addition of an appropriate amount of a substance which dissolves the above-mentioned optically and electrically functional organic material is effective for formation of a uniform thin film. It is desirable to disperse the organic material molecularly, if possible, for example, by sonication. In the present invention, the resulting solution or dispersion is referred to as a material mixture.

In the present invention, an inert gas atmosphere means an atmosphere which neither damages the organic material applied as a coating nor the substrate chemically or physicochemically. It is preferred that the concentrations of substances such as moisture and oxygen which are likely to ruin the inert atmosphere during film formation, in the medium and the coating atmosphere, preferably in both of them, are 100 ppm or less. If their concentrations exceed that, the initial performance and the durability of the coating of the optically and electrically functional organic material can be badly affected during or after coating, during being assembled into a device or a module, or during the use of the resulting devise or module. Other possible detrimental substances than moisture and oxygen include halogens such as chlorine, acid substances such as acetic acid, hydrogen chloride, sulfuric acid and nitric acid, alkaline substances such as sodium hydroxide, potassium hydroxide and ammonia, oxidants such as hydrogen peroxide and ozone, reductants such as hydrogen and carbon monoxide and other reactive substances.

In the present invention, a thin film is formed by spraying the above-mentioned material mixture in an inert gas atmosphere to coat the substrate. The material mixture may be sprayed from a pressure liquefier, if necessary through a capillary tube, after pressure adjustment in some cases. It is also effective to heat the material mixture during coating so that the material mixture does not unnecessarily solidify as it cools down due to adiabatic expansion upon the gasification of the adiabatically released material mixture.

In the present invention, the coating may be done continuously or batchwise, depending on the purpose. In continuous coating, the substrate to be coated is introduced continuously from an entrance slit to the coating zone kept under an inert gas atmosphere and carried at constant speed while it is being provided with the necessary coating. The coated substrate is carried from an exit slit similar to the entrance slit to the outside or to the next step. Therefore, it is basically preferred to keep the coating zone basically under pressure (higher than atmospheric pressure) in terms of operation.

On the other hand, in batchwise coating, before the substrate is provided with a necessary coating, the substrate to be coated is put in a coating zone previously brought under an inert gas atmosphere, or the substrate is previously loaded into the coating zone and then the atmosphere in the coating zone is replaced with an inert gas.

So-called solid coating over a given area with one material and so-called segment coating or dot coating over precisive small areas with different materials are possible as well. For problems about uniformity and efficiency in solid coating, which is usually intended for large areas, a scanning method in which either or both of the substrate and the nozzle from which a coating material is sprayed are moved, while the distance between them and the atmosphere are controlled, is effective.

On the other hand, in the case of segment coating or dot coating, it is important to effectively coat precisive areas only equally and uniformly while avoiding the coating material from diffusing or scatter beyond the target segments or dots. For this purpose, various means such as masking the other nontarget segments or dots or blowing an inert gas around the nozzle are conceivable. These coating procedures are preferably carried out under the control of a computer in view of uniformity, efficiency and accuracy of coating.

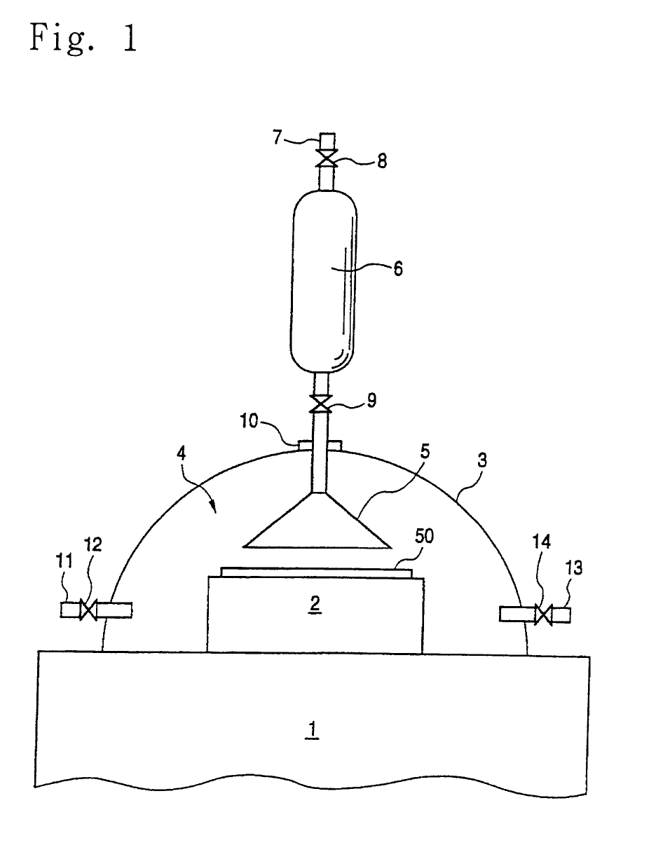

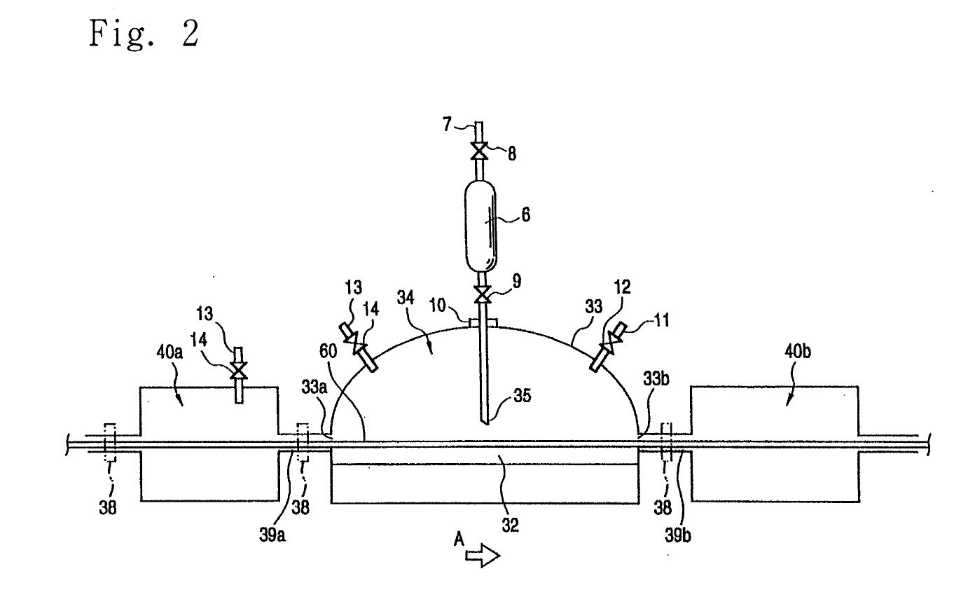

Now, an embodiment of an apparatus for forming a thin film by the novel method of the present invention is explained in reference to FIG. 1 and FIG. 2.

The apparatus for forming a thin film of the present invention shown in FIG. 1, comprises a base 1, a substrate holder 2 mounted on the base 1, an outer wall surrounding the substrate holder 2, an outer wall which covers the substrate holder 2 and a coating chamber 4 bordered by the surface of the base 1, the surface of the substrate holder 2 and the outer wall 3. Over the substrate holder 2 is one end of a spraying means penetrating the outer wall 3. At the end of the spraying means is an exhaust nozzle in the shape of a funnel splaying out toward the substrate holder 2. The other end of the spraying means outside of the outer wall 3 is connected to a pressure vessel 6 from which a material mixture obtained by dissolving or dispersing an optically and electrically functional organic material in a medium which is gaseous at ordinary temperature under atmospheric pressure and liquefies at ordinary temperature under a pressure of 100 atom or less, is sprayed through the exhaust nozzle 5. The pressure vessel 6 is connected via a valve 8 to a material inlet 7, through which the optically and electrically functional organic material is fed to the pressure vessel 6.

The spraying means is equipped with a valve 9 as a valve means which adjusts the flow between the exhaust nozzle 5 and the pressure vessel 6. On the outer wall 3, a connection joint 10 is provided around the spraying means penetrating the outer wall 3 together with an appropriate sealing means.

An inert gas is introduced from an inert gas inlet 11 provided at a certain position on the outer wall to fill the coating chamber 4. In this embodiment, the inert gas inlet 11 is provided near the end of the outer wall 3 (on the left side in the Figure) so as not to block the flow of the material mixture from the exhaust nozzle 5 of the spraying means to the substrate holder 2. The inert gas inlet 11 is also equipped with a valve 12 to adjust the inflow of the inert gas. To make up the loss of the inert gas in the coating chamber 4, it is preferred to introduce the inert gas into the internal space of the coating chamber 4 when occasion requires.

The gas mixture of the inert gas and the material mixture is exhausted from the coating chamber through a gas mixture outlet 13 on the outer wall 3 to keep the pressure in the coating chamber 4 at a constant value. In this embodiment, the gas mixture outlet 13 is provided near the end of the outer wall 3 (on the right side in the Figure) so as not to block the flow of the material mixture from the exhaust nozzle 5 of the spraying means to the substrate holder 2. The gas mixture outlet 13 is also equipped with a valve 14 to adjust the outflow of the gas mixture.

The structure of the exhaust nozzle of the spraying means is selected so as to meet the purpose. For example, it may have a shape of a funnel splaying out toward a substrate 50 as previously mentioned to spray the material mixture over a large area of the substrate 50, or may have the shape of a nozzle to spray the material mixture on a small area of the substrate 50.

FIG. 2 shows another embodiment of the apparatus for forming a thin film. Components in FIG. 2 which have the same structures and functions as those of the apparatus shown in FIG. 1 are indicated by the same or corresponding signs for the sake of simplicity with no or little explanation.

The apparatus for forming a thin film shown in FIG. 2 has a coating chamber 34 bordered by a substrate holder 32 and an outer wall 33. A spraying means penetrates the outer wall 33 and has an exhaust nozzle 35 in the shape of a nozzle on one end. From the exhaust nozzle 35, a material mixture obtained by dissolving or dispersing an optically and electrically functional organic material in a medium is sprayed onto a substrate 60 in the shape of a strip which is conveyed continuously.

An inert gas inlet 11 and a gas mixture outlet 13 are provided at certain positions on the outer wall 33.

The outer wall 33 has an entrance slit 33a near one end (on the left side in the Figure) through which the substrate is carried into the coating chamber 34, and an exit slit 33b near the other end opposite to the entrance slit 33a (on the right side in the Figure), from which the substrate 60 is carried out from the coating chamber.

A pretreatment chamber 40a and a post-treatment chamber 40b are provided ahead of and behind the coating chamber 34 in terms of the direction A of the movement of the substrate 60 in the shape of a strip to prevent the entry of moisture and air into the coating chamber 34. Connection paths 39a and 39b connect the coating chamber 34 to the pretreatment chamber 40a and to the post-treatment chamber 40b, respectively, and are optionally equipped with shutter means 38.

The coating chamber 34, the pretreatment chamber 40a and the post-treatment chamber 40b are filled with an inert gas, respectively. The inert gas pressure, especially in the coating chamber 34, should be atmospheric pressure or above.

The apparatus for forming a thin film of the present invention may be equipped with a control means to control the valves and the like to automatically control the temperature and the pressure in the coating chamber. It may also be equipped with an appropriate heating means in order to prevent the material mixture from unnecessarily solidifying as it cools down due to so-called adiabatic expansion upon the gasification of the adiabatically released material mixture.

Now, the present invention will be described in further detail with reference to an Example. However, the present invention is by no means restricted to the specific Example.

In FIG. 1, 0.1 g of purified anthracene was loaded into a stainless vessel equipped with an enclosed slide stirrer with an allowable pressure of 100 atm (internal volume 100 cc) and dried sufficiently under a reduced pressure of 100 Pa, and then monofluoromethane (critical temperature 44.6° C., critical pressure 58.0 atm) having a moisture content reduced to 1 ppm or less and an oxygen content reduced to 1 ppm or less was introduced into the pressure vessel. The resulting material mixture was stirred until the temperature and the pressure reached 50° C. and 70 atom, respectively, and the material mixture was transferred to a preliminarily evacuated pressure vessel 6 having the same volume as the above-mentioned vessel (made of stainless steel, allowable pressure of 100 atm) through the valve 8.

Separately, a substrate was prepared by coating a transparent glass electrode having an ITO film with a thin film of a dispersion of TPD (N,N′-diphenyl-N,N′-di(3-methylphenyl)-1,1′-biphenyl-4,4′-diamine) in polyvinylcarbazole having a thickness of 60 nm, maintained in an inert atmosphere using dry nitrogen as an inert gas and placed at a predetermined position (on the substrate holder 2) in the chamber 3 preliminarily brought under a similar inert atmosphere.

The internal temperature of the chamber was maintained at 50° C., and a small amount of an inert gas was introduced from the inert gas inlet 12 while about the same amount was exhausted from the outlet valve 13, and the material mixture of anthracene and monofluoromethane was gently sprayed onto the substrate for 10 seconds by carefully opening the valve 9 to form a uniform thin coat film of 60 nm in thickness. Then, the valve 9 was closed, and the substrate having the resulting thin coat film of anthracene was stored in a case having a similar inert atmosphere and made into a magnesium-silver electrode in another vacuum chamber.

When a direct current of 15 V was applied to the resulting thin film device, emission of blue light (λmax=405 nm) was observed.

### INDUSTRIAL APPLICABILITY

The present invention has the following effects.

(1) A thin film of an organic material can be formed easily with a high degree of freedom without the need for a vacuum system.

(2) The organic material can be vaporized or evaporated without heating to high temperature with no or little deterioration of the material.

(3) Drying can be accomplished in a shorter time as compared with conventional formation of a thin film using a solution.

(4) It is possible to form a film of a compound which is hardly soluble in ordinary solvents or not sublimable.

(5) It is possible to form thin films over a small area and a large area.

(6) There is no limitation on the amount of the material supplied to form a thin film because the vessel may be set out of the system so as to be replenished with the material properly.

(7) The present invention is applicable both to low-molecular weight organic compounds and to high-molecular weight compounds and has a wide scope of applications.

(8) The apparatus can be obtained at a lower cost than those using a vacuum, an electron beam, sputtering and an ion accelerator.

The entire disclosure of Japanese Patent Application No. 11-336321 filed on Nov. 26, 1999 including specification, claims, drawings and summary are incorporated herein by reference in its entirety.

What is claimed is:

1. A method for forming a thin film of an organic material, which comprises liquefying by pressurization a medium which is gaseous at ordinary temperature under 1 atom and liquefies at ordinary temperature under a pressure of 100 atom or less, dissolving or dispersing an organic material in the liquefied medium, and spraying the resulting material mixture onto a substrate in an inert gas atmosphere to coat the substrate with the organic material.

2. A method for forming a thin film of an organic material, which comprises bringing a medium having a critical temperature of ordinary temperature or lower and a critical pressure of 100 atm or less into a supercritical state, dissolving or dispersing an organic material in the medium, and spraying the resulting material mixture onto a substrate in an inert gas atmosphere to coat the substrate with the organic material.

3. The method for forming a thin film of an organic material according to claim 1, wherein the moisture concentrations in the medium and the coating atmosphere are 100 ppm or less.

4. The method for forming a thin film of an organic material according to claim 1, wherein the oxygen concentrations in the medium and the coating atmosphere are 100 ppm or less.

5. The method for forming a thin film of an organic material according to claim 1, wherein the medium is a carbon-containing compound having at most three carbon atoms.

6. The method for forming a thin film of an organic material according to claim 1, wherein the medium contains at least one member selected from carbon dioxide gas, methane, ethane, propane, chlorotrifluoromethane and monofluoromethane.

7. The method for forming a thin film of an organic material according to claim 1, wherein the organic material is a material having an optical and/or electrical function.

8. The method for forming a thin film of an organic material according to claim 2, wherein the moisture concentrations in the medium and the coating atmosphere are 100 ppm or less.

9. The method for forming a thin film of an organic material according to claim 2, wherein the oxygen concentrations in the medium and the coating atmosphere are 100 ppm or less.

10. The method for forming a thin film of an organic material according to claim 2, wherein the medium is a carbon-containing compound having at most three carbon atoms.

11. The method for forming a thin film of an organic material according to claim 2, wherein the medium contains at least one member selected from carbon dioxide gas, methane, ethane, propane, chlorotrifluoromethane and monofluoromethane.

12. The method for forming a thin film of an organic material according to claim 2, wherein the organic material is a material having an optical and/or electrical function.

13. An apparatus for forming a thin film of an organic material, which comprises a chamber portion to be loaded with a substrate which has an internal space to be filled with an inert gas, an spraying means which has an exhaust nozzle through which a material mixture obtained by dissolving or dispersing an organic material in a medium is sprayed, an introducing means which introduces the inert gas into the internal space, and an exhaustion means which exhausts the inert gas and the material mixture to keep the pressure in the internal space at a given value.

14. The apparatus for forming a thin film of an organic material according to claim 13, wherein the given value of the pressure in the internal space is set at atmospheric pressure or above.
